(19) United States
(12) Patent Application Publication
(10) Pub. No.: US 2009/0327995 A1
(43) Pub. Date: Dec. 31, 2009

(54) ANNOTATION-AIDED CODE GENERATION IN LIBRARY-BASED REPLAY

(75) Inventors: Zhenyu Guo, Beijing (CN); Xuezheng Liu, Beijing (CN); Zheng Zhang, Beijing (CN)

Correspondence Address: LEE & HAYES, PLLC, 601 W. RIVERSIDE AVENUE, SUITE 1400, SPOKANE, WA, 99201, US

(73) Assignee: Microsoft Corporation, Redmond, WA (US)

(21) Appl. No.: 12/163,725

(22) Filed: Jun. 27, 2008

(51) Int. Cl. G06F 9/44

(52) U.S. Cl. 717/106

(57) ABSTRACT

Techniques for automatically generating replay-enabling code in a library based replay system. The technique requires a code template programmed by an operating system developer. Then, utilizing an application programming interface (API) annotation, either standard or user-defined, customized replay-enabled code is automatically generated for every specific API.

### RELATED APPLICATION

This application is related to commonly-filed application Ser. No. ______, entitled “Space Separation for a Library Based Record and Replay Tool”, both of which are commonly assigned to Microsoft Corp., the disclosure of which is incorporated by reference herein.

### BACKGROUND

Modern computing environments are typically multi-threaded, employ advanced features such as asynchronous input/output, and often exist in a distributed environment. Traditional cyclic debugging processes struggle with such a complex environment and, as a result, the environment has become increasingly challenging for developers to debug.

One existing solution for de-bugging such a computing environment is a technique referred to as deterministic replay. Deterministic replay is a powerful approach for de-bugging multi-threaded and distributed applications. Deterministic replay can bring together all relevant states spread across numerous machines in a distributed system, removing non-determinism, and thus re-enabling the cyclic de-bugging process.

A second solution for de-bugging complex computing environments is a library based deterministic replay. The library based deterministic replay process utilizes a lot of what is referred to as replay-enabling code. However, these existing approaches require that each replay-enabling code be coded manually, which is not only tedious, but manually coding may also lead to the introduction of a multitude of errors during the de-bugging process. Therefore, there is a need for automated generation of replay-enabling code.

### SUMMARY

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Methods and systems for automatically generating replay-enabling code are described. The automatic generating provides for faithful replay in a library-based deterministic replay system.

In one embodiment, an application program interface (API) function is intercepted by a virtual execution layer. The API function is then encapsulated by a code wrapper generated by annotation information. In addition, the annotation information also generates code snippets, which may be referred to as slots. The code wrapped API function is then converted into a flexible extension structure, where the flexible extension structure is plugged into the generated slots.

Automatic generation of replay enabling code reduces the need for hand-coding of API functions. Furthermore, the use of annotation-aware code generation increases the efficiency and robustness of a library-based deterministic replay system.

### BRIEF DESCRIPTION OF THE DRAWINGS

The detailed description is described with reference to the accompanying figures. In the figures, the left-most digit of a reference number identifies the figure in which the reference number first appears. The use of the same reference numbers in different figures indicates similar or identical items.

FIG. 1 illustrates a block diagram of an exemplary replay tool.

FIG. 2 illustrates a block diagram of a space separation according to FIG. 1.

FIG. 3 illustrates an annotation-aware code generation according to FIG. 2.

FIG. 4 is a flow diagram that describes a process for generating an annotation-aware code according to one embodiment.

FIG. 5 illustrates a block diagram of an exemplary computing environment.

### DETAILED DESCRIPTION

This disclosure is directed to techniques for automatically generating a replay-enabling code. The technique requires a code template programmed by an operating system developer. Then, utilizing an application programming interface (API) annotation, either standard or user-defined, a customized code is automatically generated for every specific API.

### Exemplary Replay Tool

The following discussion of an exemplary system provides the reader with assistance in understanding ways in which various subject matter aspects of the system, methods, and computer program products may be employed. The system described below constitutes but one example and is not intended to limit application of the subject matter to any one particular operating system.

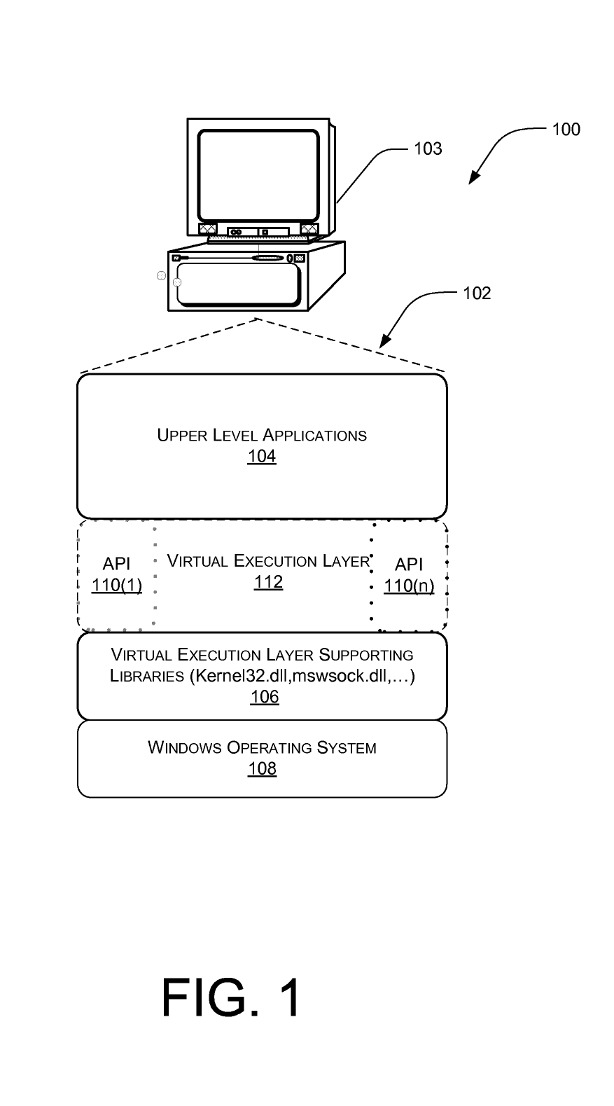

FIG. 1 is an overview block diagram of an exemplary system 100 including a replay tool 102 and a computing device 103. Computing devices 103 that are suitable for use with the system 100, include, but are not limited to, a personal computer, a laptop computer, a desktop computer, a digital camera, a personal digital assistance, a cellular phone, a video player, and other types of image sources. Replay tool 102 permits a deterministic simulation within a library based replay system, by which, a user may log pertinent information thereby ensuring that each input always produces the same output.

As depicted in the replay tool 102, there are upper application(s) 104 which communicates with the underlying library(ies) 106 and the operating system(s) 108 via a multitude of application program interface (API) functions 110(1)-110(n). The API functions exist in what may be referred to as a virtual execution layer 112. The virtual execution layer 112 represents a natural boundary between the upper application 104 and the underlying supporting infrastructure including, without limitation, the library 106 and the operating system 108.

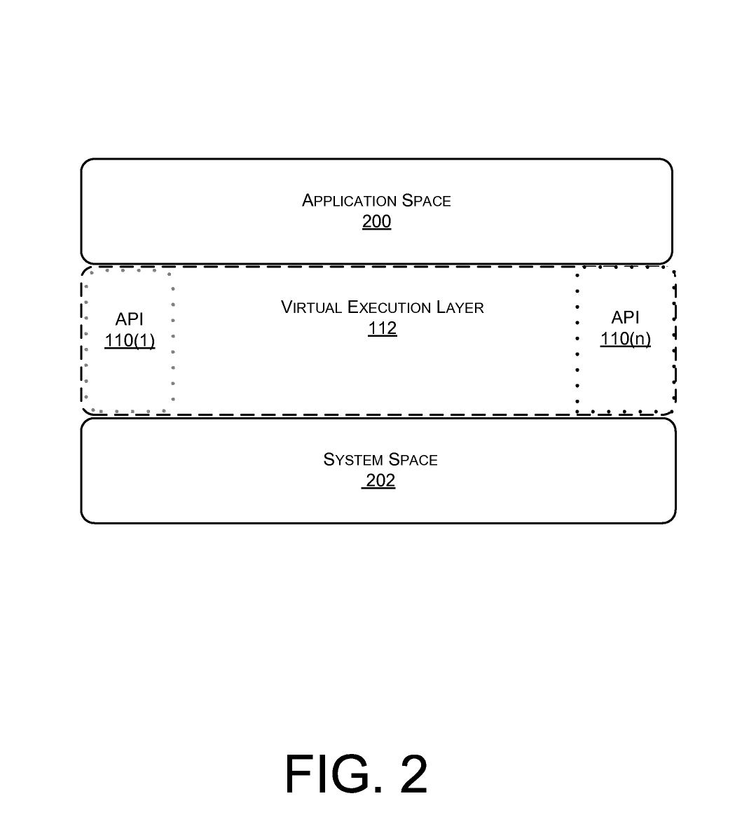

FIG. 2 is a block diagram illustrating a space separation according to FIG. 1. As illustrated in FIG. 2, the virtual execution layer 112 is flanked by two subspaces. Above the virtual execution layer is an application space 200, while below the virtual execution layer is a system space 202. All of the logic of the replay tool 102, including without limitation, logging and replaying, resides in the system space 202 along with the library 106 and the operating system 108.

Separation between the application space 200 and the system space 202 is typically done at an entry and a return point of intercepted API functions 110(1)-110(n) by setting a thread specific flag. An exception to this typical separation format is user functions that are invoked from the system space 202. These functions are referred to as exceptional control flow. These functions are typically callback events, discussed below, and the functions are registered either explicitly or implicitly. Examples of these include but are not limited to, asynchronous ReadFileEx with callback events, and message handler registration in many distributed systems. Message handler registrations may include, for example, per-thread dynamic-link library (DLL) initializations on Windows. While a routine is designated when the thread is created, the actual execution of the thread will first invoke entry points of an in-process DLL. This kind of callback registration is done automatically at run time by the underlying operating system.

### Interception

To utilize the replay tool 102, API functions 110(1)-110(n) should be intercepted, wrapped and converted to a SignalEx structure. Today's operating system often has a rich set of system API functions 110(1)-110(n), which may include more than 1000 functions. Therefore, this can be a challenging task.

In one implementation, forming of the virtual execution layer 112 allows the replay tool 102 to intercept the API functions 110(1)-110(n) using a technique referred to as a detour. However, in alternative implementations other techniques may be used to intercept the API functions. A detour is a library for intercepting functions. The detour operates by replacing the first few instructions of the target function with a jump to the user-provided detour function. Detours are typically inserted at the time of execution. The code of the target function is modified in memory, not on a disk, therefore permitting interception of the API functions 110(1)-110(n) at a very fine level. For example, the procedures in a dynamic link library (DLL) can be detoured in one execution of an application, while the original procedures are not detoured in another execution running at the same time. In general, techniques used in the detour library work regardless of the method used by the upper level application 102 or system code to locate the target function.

### Wrapper and Slots

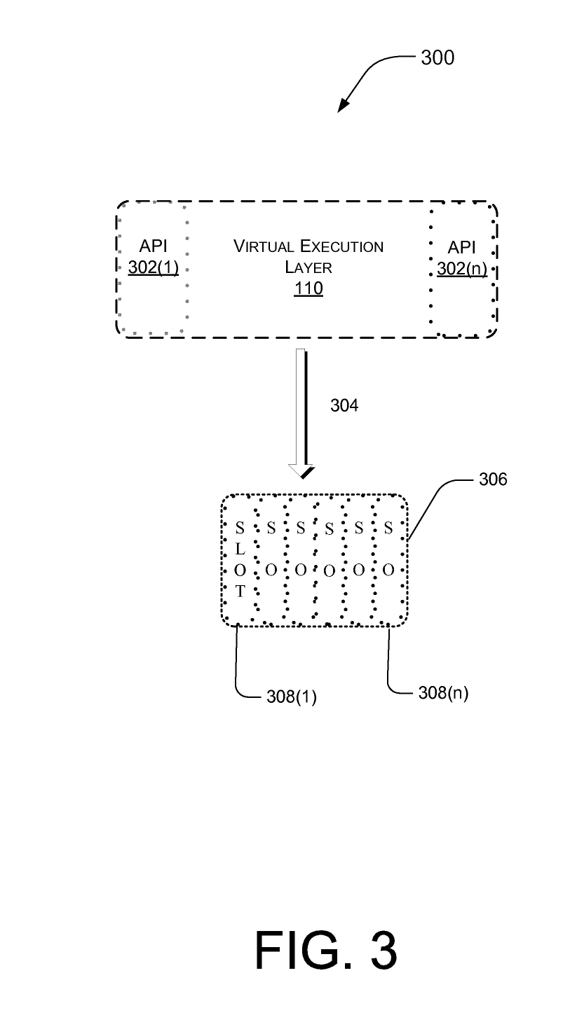

FIG. 3 illustrates an annotation-aware code generation according to FIG. 2. Following interception of the API functions 110(1)-110(n), the API functions are wrapped. A wrapper is an object that encapsulates and delegates to another object, with the aim of altering the objects behavior or interface. As shown in FIG. 3, the wrapped API functions 302(1)-302(n) take charge of dispatching the execution into the correct subspace, that is, either the application space 200 or the system space 202. In addition, the wrapped API functions direct the execution of a thread 304 into a signal-slot process 306 when the execution of 304 leaves application space 200 and enters system space 202. The signal-slot process 306 includes slots 308(1)-308(n), which perform various jobs for log-replay such as logging function output, enforcing deterministic scheduling, and feeding function output.

Hand coding of these wrappers and slots is tedious and error-prone. Therefore, instead of implementing the wrappers and slots on each API function, programmers annotate function prototypes and the wrappers as well as slots are then automatically generated according to these annotations. Annotation-aware code generation enables large scale interception of API functions 1108(1)-110(n) and code generation for log and replay, further enabling the flexibility to redefine the interception layer.

Most Windows® functions are well annotated in a Standard Annotation Language (SAL) as shown in recent Windows® Platform Software Development Kits. The functions concisely describe various aspects of attributes as well as parameters of the API functions 110(1)-110(n) and form the basis for annotation-aware code generation. For example, SAL, may include, without limitation:

int recv(
_in SOCKET s,
_out_bcount_part(len, return) char * buf,
_in int len,
_in int flags
);

In this example, “in” indicates that parameters s, len and flags are input parameters; “out” indicates that buf is the output buffer that must be logged for replay, with “bcount” to specify its initial length is len and the result length is the return value.

Special attention may be required for exchanging data across spaces, for example, application space 200 and system space 202. For most API Functions 110(1)-110(n) a caller is responsible to prepare and to manage the buffer, and the API Function 110(1)-110(n) just needs to fill the buffer. Therefore, a user would need to copy the content of the buffer to the log. However, other functions return a buffer that is allocated internally. For example, inet_ntoa returns a string for a given network address, in which the buffer is maintained by the callee rather than the caller.

This presents a few challenges. First, it is generally unsafe to re-execute these API Functions 110(1)-110(n) at replay time and hope that the outputs match exactly with the original run. Second, even if the content of the execution is reproducible, the call can return a pointer that may differ from the original run. If an application were to use this pointer as an input, state corruption would inevitably occur. This problem can be addressed by allocating a shadow copy, permitting manual or automatic backup copies of that specific point in time. Returning the shadow copy to the application at both the logging and replay time circumvents potential non-determinism issues caused by these API functions. The annotation xpointer instructs the script to generate appropriate codes. Specifically:
An API function may allocate a new buffer in each call; meanwhile it must have a paired “free” API function. XPointers are used to specify such buffers. For example: getaddrinfo and freeaddrinfo, GetEnvironmentStrings and FreeEnvironmentStrings.
An API function returns a global/per-thread internal buffer; usually the returned buffer is guaranteed to be valid only until the next corresponding call. For example, GetcommandLine and inet_ntoa.

XPointer(global)/xpointer (tls) are used to indicate that the buffer is taken from a global/per-thread internal buffer space.

Table 2 provides a summary of annotations that are used in addition to those provided by SAL.

TABLE 2

| Annotation | Indication | Action |
|---|---|---|
| xpointer(kind) | memory allocated in | Make a shadow copy of the |
| | system space | memory in application space |
| prepare(key, | function issues an | Register buf upon key |
| buf) | asynchronous I/O | |
| commit(key, | function indicates an | Query buffer pointer upon |
| size) | asynchronous | key, and log the buffer with |
| | I/O is completed | designated size |
| callback | parameter callback | Wrap the function pointer so |
| | function pointer | that its execution will be in |
| | | application space |
| sync(key) | function causality | used to track causalities of |
| | among syscalls and | related API functions |
| | upcalls (key can be | |
| | any expression) | |
| succ | success condition | Log only when the condition |
| | | is met, thus the logger ignores |
| | | output parameters on |
| | | functions that fail to satisfy |
| | | their succ conditions to |
| | | reduce log time and size. For |
| | | example most of the |
| | | traditional API Functions |
| | | succeed when the return |
| | | value is not zero. |

### Event-Based Replay

Replay tool 102 operates as an event-based tool. For example, as discussed above, the wrapped API functions 302(1)-302(n) direct the execution of thread 304 into the correct slot within the signal-slot process 306. Typically, the execution of the thread 304 is viewed as a succession of three types of events. These three events include, includes, but is not limited to, an API event, a continuation event, and a callback event. The API event is an invocation of an intercepted API functions 110(1)-110(n). The API event segments the thread execution into the continuation events. Some of these API functions may take callback routines that will be executed at some future points, and the invocations are the callback events.

A multi-threaded, distributed application is a collection of these three events from the various events running on the distributed computing devices. The task of logging these events includes at least two steps. First, numbering of the events, and second, recording the output of the API events such that the replay tool 102 can process these events in increasing order while feeding the outputs of the API events from the log. This ensures that the internal state of the application can be faithfully recreated as dictated by the application logic.

The events are numbered by assigning each event a 64-bit integer that is a logical clock. Logical clocks are assigned within a process, without limitation, by one of two main approaches. First, logical clocks are assigned through use of a customized scheduler which defines scheduling points at a boundary of the intercepted API functions 110(1)-110(n). The second approach begins with each thread inheriting a logical clock from its creator. The logical clock is then modified to reflect a relationship among events by capturing the relationship between the various API events that access the same resource. A shadow memory block is allocated behind each resource such that it may store, without limitation, the thread ID and the logical clock of the last API event that accessed the resource. When an API event accesses a resource, the corresponding logical clock is updated with the maximum of either its own clock or that of the last logical clock value recorded on the shadow memory block, therefore processing events in the order as determined by the logical clock.

Logical clock values may also be assigned across processes using a layered service provider. A layered service provider implements only higher-level communication functions while relying on an underlying transport stack for the actual exchange of data with a remote endpoint. Such communication may, for example and without limitation, take place by transferring messages through the use of a socket. A socket is an identifier for a particular service on a particular node of a network. The socket includes a node address and a part number, identifying the service. The layered service provider will build a filter and a message processing layer. All socket based messages with travel through this layer, whereby a logical clock is embedded in the outgoing message and extracted as it enters. Such a process is transparent to the application.

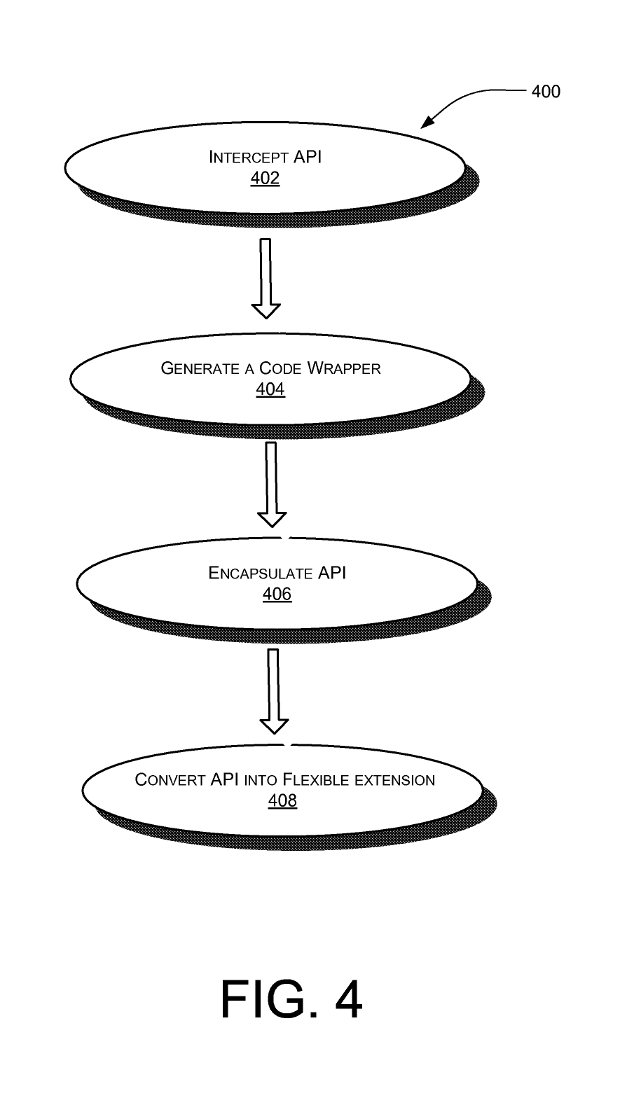

FIG. 4 is a flow diagram that describes a process for generating an annotation-aware code according to one embodiment. For ease of understanding, the process 400 is delineated as separate steps. However, these separately delineated steps should not be construed as necessarily order dependent in their performance. The order in which the process is described is not intended to be construed as a limitation, and any number of the described process blocks maybe be combined in any order to implement the method, or an alternate method. Moreover, it is also possible that one or more of the provided steps may be omitted.

As illustrated in FIG. 4, in one embodiment, an API function is intercepted at step 402 by a virtual execution layer. In step 404, a code wrapper is generated, encapsulating the API function in step 406. The code wrapped API function is then converted into a flexible extension structure at 408, where the flexible extension structure is plugged into slots contained in a signal-slot process.

### Computing Environment

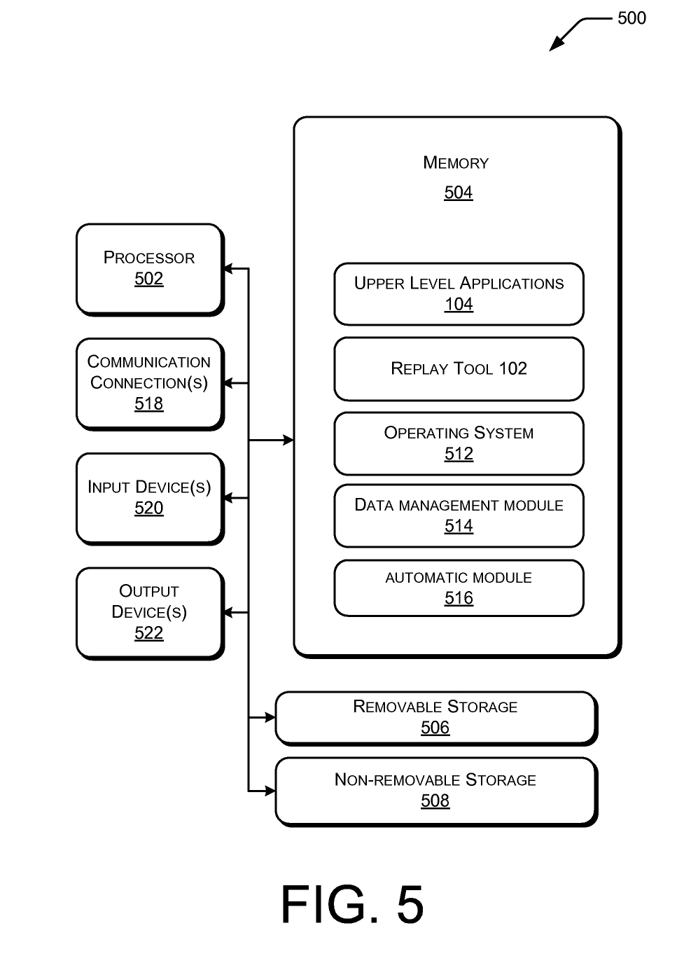

FIG. 5 is a schematic block diagram of an exemplary general operating system 500. The system 500 may be configured as any suitable system capable of implementing the replay tool 102. In one exemplary configuration, the system comprises at least one processor 502 and memory 504. The processing unit 502 may be implemented as appropriate in hardware, software, firmware, or combinations thereof. Software or firmware implementations of the processing unit 502 may include computer- or machine-executable instructions written in any suitable programming language to perform the various functions described.

Memory 504 may store programs of instructions that are loadable and executable on the processor 502, as well as data generated during the execution of these programs. Depending on the configuration and type of computing device, memory 504 may be volatile (such as RAM) and/or non-volatile (such as ROM, flash memory, etc.). The system may also include additional removable storage 506 and/or non-removable storage 508 including, but not limited to, magnetic storage, optical disks, and/or tape storage. The disk drives and their associated computer-readable medium may provide non-volatile storage of computer readable instructions, data structures, program modules, and other data for the communication devices. Memory 504, removable storage 506, and non-removable storage 508 are all examples of the computer storage medium. Additional types of computer storage medium that may be present include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by the computing device 103.

Turning to the contents of the memory 504 in more detail, may include an upper level application 104, an operating system 514, one or more replay tools 102. For example, the system 500 illustrates architecture of these components residing on one system or one server. Alternatively, these components may reside in multiple other locations, servers, or systems. For instance, all of the components may exist on a client side. Furthermore, two or more of the illustrated components may combine to form a single component at a single location. In one implementation, the memory 504 includes the replay tool 102, a data management module 514, and an automatic module 516. The data management module 514 stores and manages storage of information, such as images, ROI, equations, and the like, and may communicate with one or more local and/or remote databases or services. The automatic module 516 allows the process to operate without human intervention. The system 500 may also contain communications connection(s) 518 that allow processor 502 to communicate with servers, the user terminals, and/or other devices on a network. Communications connection(s) 518 is an example of communication medium. Communication medium typically embodies computer readable instructions, data structures, and program modules. By way of example, and not limitation, communication medium includes wired media such as a wired network or direct-wired connection, and wireless media such as acoustic, RF, infrared and other wireless media. The term computer readable medium as used herein includes both storage medium and communication medium. The system 500 may also include input device(s) 520 such as a keyboard, mouse, pen, voice input device, touch input device, etc., and output device(s) 522, such as a display, speakers, printer, etc. The system 500 may include a database hosted on the processor 502. All these devices are well known in the art and need not be discussed at length here.

### CONCLUSION

Although embodiments for automatic generation of code have been described in language specific to structural features and/or methods, it is to be understood that the subject of the appended claims are not necessarily limited to the specific features or methods described. Rather, the specific features and methods are disclosed as exemplary implementations.

What is claimed is:

1. A method for automatically generating a replay-enabling code, the method comprising:
intercepting one or more application program interface (API) functions;
generating one or more code wrappers and one or more slots utilizing annotation information;
encapsulating the one or more API functions with the one or more code wrappers; and
converting one or more wrapped API functions into one or more flexible extension structures.

2. The method of claim 1, wherein the one or more API functions are located in a virtual execution layer.

3. The method of claim 2, wherein the virtual execution layer comprises representing a boundary between a program and an underlying support infrastructure.

4. The method of claim 1, wherein the one or more flexible extensions comprises a SignalEx® object.

5. The method of claim 4, wherein the SignalEx®(g object comprises treating the one or more API functions as a signal-slot process comprising the one or more slots, wherein the SignalEx® is plugged into the one or more slots.

6. The method of claim 1, further comprising an application reading the annotation information to generate code wrapper information.

7. The method of claim 1, further comprising a device reading the annotation information to generate code wrapper information.

8. The method of claim 1, wherein the one or more API functions comprises being annotated in a Standard Annotation Language (SAL).

9. One or more computer-readable storage media containing instructions that are executable by a computing device to perform actions comprising:
intercepting one or more application program interface (API) functions;
encapsulating the one or more API functions with a code wrapper;
converting a wrapped API function into a flexible extension, wherein the flexible extension treats the wrapped API function as one or more slots of a linked list; and
executing the one or more slots of the linked list.

10. The one or more computer-readable storage media of claim 9, wherein the linked list comprises being dynamically reconfigured.

11. The one or more computer-readable storage media of claim 9, further comprising a wrapped API function utilizing a script to convert the one or more wrapped API function into the flexible extensions.

12. The one or more computer-readable storage media of claim 11, wherein the script comprises generating a slot to record contents of output parameters.

13. A system for automatically generating a replay-enabling code, the system comprising:
a processor;
a memory coupled to the processor;
a virtual execution layer stored in the memory;
one or more application program interface (API) functions existing in a virtual execution layer;
a linked-list, wherein the one or more API functions emit a signal triggering a slot within the linked-list to be executed.

14. The system of claim 13, wherein the one or more API functions existing in the virtual execution layer comprises encapsulating with a code wrapper generated from annotation information creating one or more code wrapped API functions.

15. The system of claim 14, wherein the one or more code wrapped API functions comprises converting into one or more flexible extensions.

16. The system of claim 13, wherein the linked list comprises one or more distinctive slots that are executed one by one.

17. The system of claim 16, wherein the one or more distinctive slots comprises a log slot and a replay slot tool.

18. The system of claim 17, wherein the log slot comprises recording the output parameters of the one or more APIs calls.

19. The system of claim 18, wherein the logging information comprises collecting on a separate memory device.

20. The system of claim 18, wherein the replay slot comprises feeding the linked list from the logged output parameters.
